(19) United States
(12) Patent Application Publication
(10) Pub. No.: US 2013/0134119 A1
(43) Pub. Date: May 30, 2013

(54) Product Display and Loading System

(71) Applicants: Caleb S. Loftin, Richmond, VA (US); Matthew E. Zacherle, Richmond, VA (US)

(72) Inventors: Caleb S. Loftin, Richmond, VA (US); Matthew E. Zacherle, Richmond, VA (US)

(21) Appl. No.: 13/306,126

(22) Filed: Nov. 29, 2011

(51) Int. Cl. A47F 1/04; B65B 5/10; G09F 17/00

(52) U.S. Cl. 211/59.2; 40/604; 53/475

(57) ABSTRACT

A product display and loading system including a shelf assembly that includes a generally horizontal shelf member having a forward end and a rear end, and a product dispenser positioned on the shelf member, the product dispenser being spaced from the forward end to define a loading surface proximate the forward end.

### FIELD

This application relates to point-of-sale displays and, more particularly, to systems and methods for displaying products to consumers.

### BACKGROUND

Products are typically shipped to retailers in bulk by enclosing multiple individual product units in a container, such as a carton or box. For example, canned foods may be shipped to a retailer in a box containing twenty-four individual cans. Then, it is typically the retailer's obligation to remove the individual product units from the container and present them on a display, such as a shelf, where the products may be retrieved by consumers.

Alternatives to the traditional package-ship-unpack-display model have been developed in an effort to improve operating efficiency. For example, U.S. Pat. No. 7,922,437 (issued on Apr. 12, 2011) discloses a product dispensing system that includes a dispenser having a support structure, a product display area and an opening tool. The dispenser may be positioned on a retailer's shelf and loaded with product simply by placing a container comprising multiple units of product onto the support structure of the dispenser. As the container is being placed onto the support structure, the opening tool of the dispenser opens the container in such a manner that product rolls from the container and down to the product display area of the dispenser under the force of gravity.

Thus, product dispensing systems include a product display area from which consumers may easily retrieve products. When one product is removed from the product display area, another product in the dispenser moves to the product display area under the force of gravity. Therefore, consumers may retrieve multiple products from a single product dispensing system.

Furthermore, multiple product dispensing systems may be positioned on a single display. Each product dispensing system may be loaded with a different product, thereby presenting the consumer with various product options. Additional product dispensing systems may also be used to dispense popular products, thereby increasing availability of the popular product.

Accordingly, there is a need for a product display and loading system that may enable consumers to conveniently retrieve and load multiple products from one or more product dispensing systems.

### SUMMARY

In one aspect, the disclosed product display and loading system may include a shelf assembly including a generally horizontal shelf member having a forward end and a rear end, and a product dispenser positioned on the shelf member, the product dispenser being spaced from the forward end to define a loading surface proximate the forward end.

In another aspect, the disclosed product display and loading system may include a shelf assembly including a generally horizontal shelf member having a forward end and a rear end; a plurality of product dispensers positioned on the horizontal shelf member, the product dispensers being spaced from the forward end to define a loading surface proximate the forward end; and a plurality of loading containers supported on the shelf assembly, wherein each loading container is sized to fit between the forward end and the product dispensers when the loading container is positioned on the loading surface.

In yet another aspect, disclosed is a method for loading a product from a product display into a loading container. The method may include the steps of (1) providing a shelf assembly including a generally horizontal shelf member having a forward end and a rear end; (2) positioning a product dispenser on the horizontal shelf member such that the product dispenser is spaced from the forward end of the horizontal shelf member to define a loading surface proximate the forward end, the product dispenser supporting the product; (3) positioning the loading container on the loading surface; and (4) transferring the product from the product dispenser to the loading container.

Other aspects of the disclosed product display and loading system and method will become apparent from the following detailed description, the accompanying drawings and the appended claims.

### BRIEF DESCRIPTION OF THE DRAWINGS

FIG. 1 is a front perspective view of one aspect of the disclosed product display and loading system;

FIG. 2 is a front elevational view of the shelf assembly of the product display and loading system of FIG. 1;

FIG. 3 is a side elevational view, in section, of the shelf assembly of FIG. 2;

FIG. 4 is a front and side perspective view of one product dispenser of the product display and loading system of FIG. 1;

FIG. 5 is a side elevational view, in section, the product dispenser of FIG. 4;

FIG. 6 is a front perspective view of one loading container of the product display and loading system of FIG. 1; and

FIG. 7 is a front perspective view of the product display and loading system of FIG. 1, shown with a loaded loading container supported on the shelf assembly.

### DETAILED DESCRIPTION

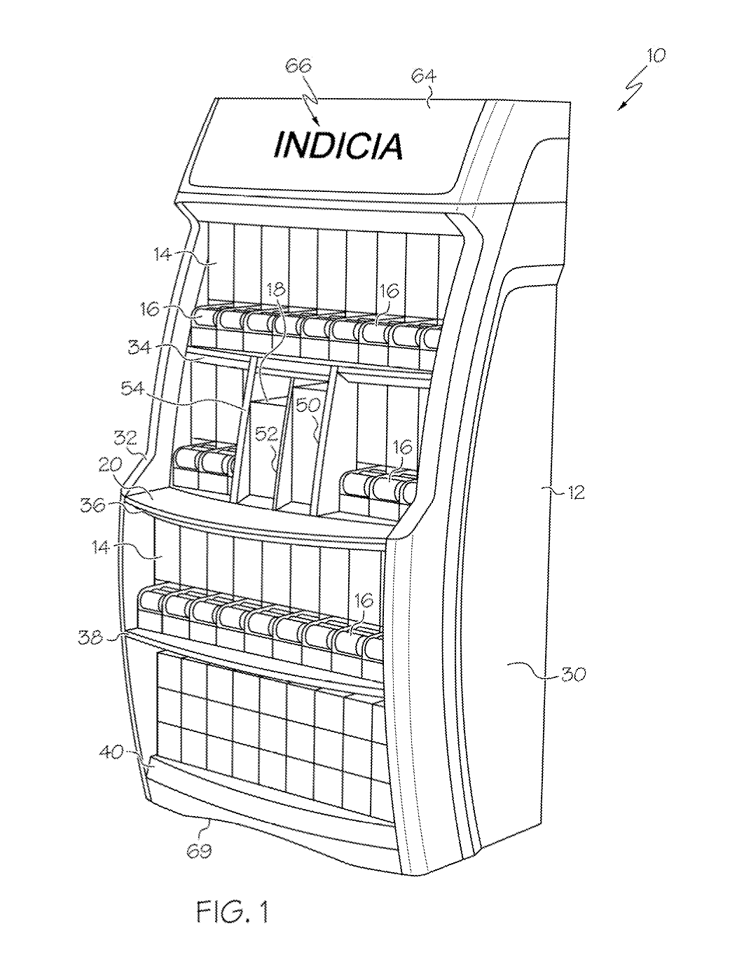

Referring to FIG. 1, one aspect of the disclosed product display and loading system, generally designated 10, may include a shelf assembly 12 and one or more product dispensers 14. The product dispensers 14 may be positioned on the shelf assembly 12 and loaded with products 16. Optionally, one or more loading containers 18 may also be positioned on the shelf assembly 12.

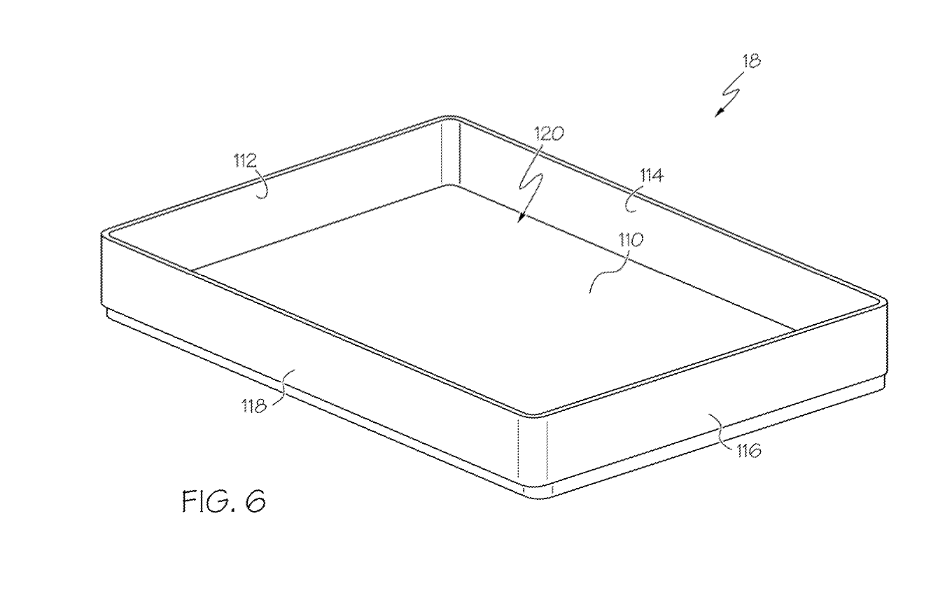

Thus, consumers may retrieve one or more products 16 from the product dispensers 14 and may load the retrieved products 16 into one or more of the loading containers 18. To simply the process of loading a loading container 18 with products 16 retrieved from the product dispensers 14, the loading container 18 may be placed on a loading surface 20 of the shelf assembly 12 during the loading process, as shown in FIG. 6, thereby allowing consumers to use both hands during the loading process.

Accordingly, the disclosed product display and loading system 10 may display various products 16 to consumers, and may facilitate the process of retrieving products 16 from the product dispensers 14 and loading the retrieved products 16 into a loading container 18.

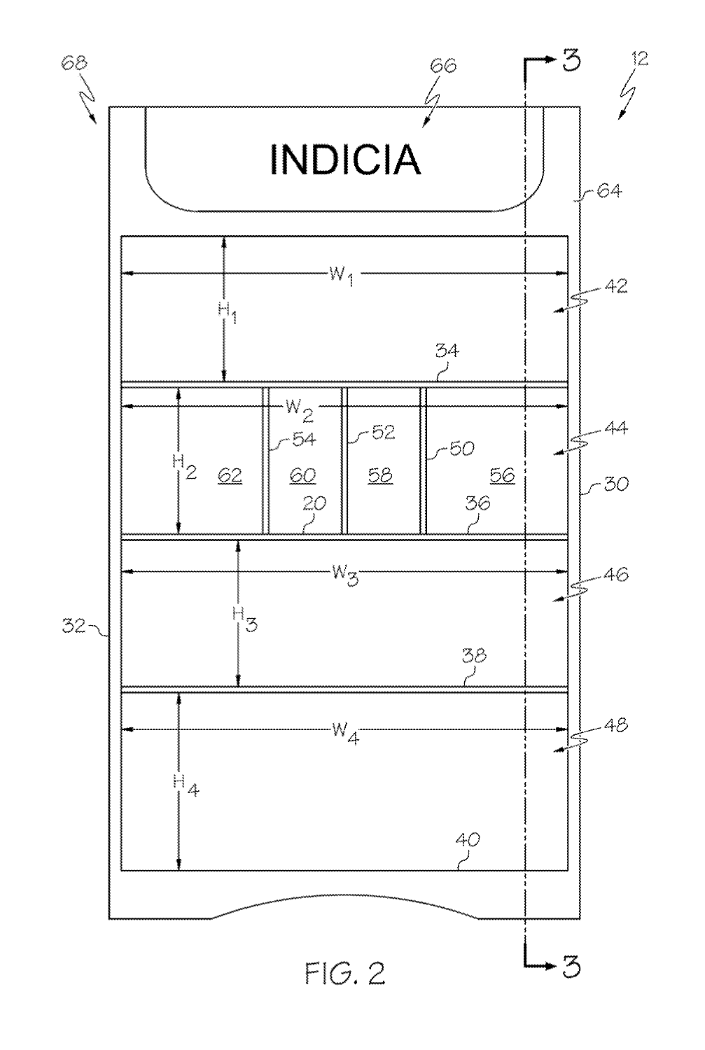

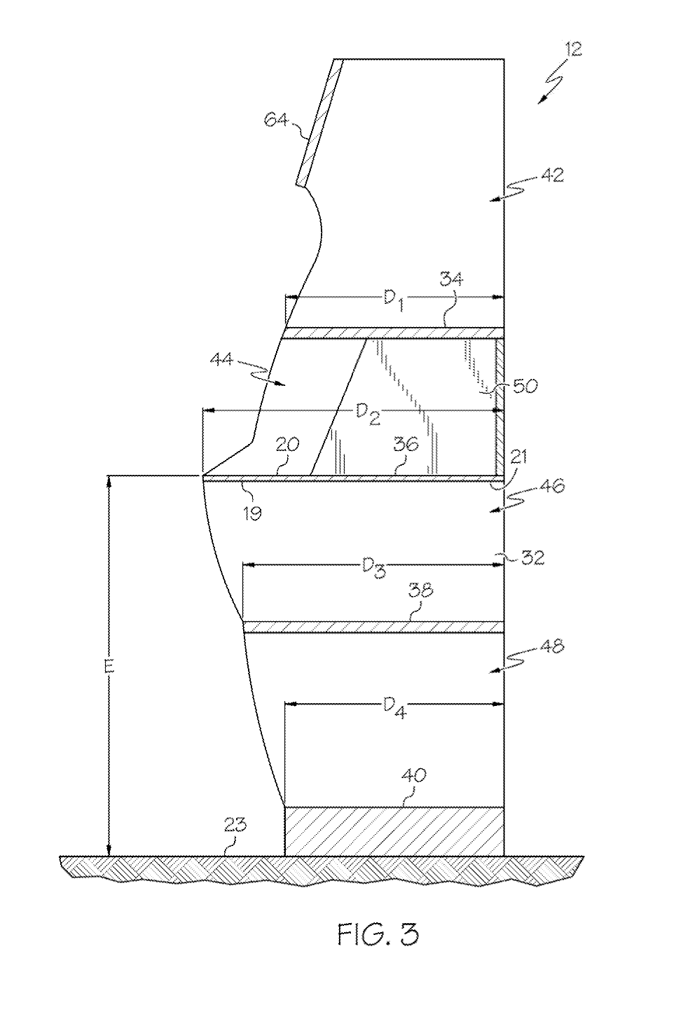

As shown in FIGS. 2 and 3, the shelf assembly 12 may include a first (right) side wall 30, a second (left) side wall 32, a first horizontal shelf member 34, a second horizontal shelf member 36, a third horizontal shelf member 38 and a fourth horizontal shelf member 40.

The first horizontal shelf member 34 may laterally extend between the right and left side walls 30, 32, and may define a first shelf 42 of the shelf assembly 12. The first shelf 42 may have a lateral width W₁ (FIG. 2), a vertical height H₁ (FIG. 2) and a shelf depth D₁ (FIG. 3).

The second horizontal shelf member 36 may laterally extend between the right and left side walls 30, 32, and may define a second shelf 44 of the shelf assembly 12. The second shelf 44 may have a lateral width W₂ (FIG. 2), a vertical height H₂ (FIG. 2) and a shelf depth D₂ (FIG. 3).

The second horizontal shelf member 36 may include a forward end 19 and a rear end 21, and may define the loading surface 20 proximate the forward end 19. As shown in FIG. 3, the second horizontal shelf member 36 may elevated from the support surface 23 upon which the base 69 of the shelf assembly 12 sits by a distance E, thereby presenting the loading surface 20 at a desired loading surface height relative to the support surface 23. For example, the distance E may range from about 30 to about 48 inches, thereby presenting the loading surface 20 at a convenient loading surface height for consumers. As a specific example, the distance E may be about 36 inches.

The third horizontal shelf member 38 may laterally extend between the right and left side walls 30, 32, and may define a third shelf 46 of the shelf assembly 12. The third shelf 46 may have a lateral width W₃ (FIG. 2), a vertical height H₃ (FIG. 2) and a shelf depth D₃ (FIG. 3).

The fourth horizontal shelf member 40 may laterally extend between the right and left side walls 30, 32, and may define a fourth shelf 48 of the shelf assembly 12. The fourth shelf 48 may have a lateral width W₄ (FIG. 2), a vertical height H₄ (FIG. 2) and a shelf depth D₄ (FIG. 3).

While four horizontal shelf members 34, 36, 38, 40 are shown defining four shelves 42, 44, 46, 48 of the shelf assembly 12, those skilled in the art will appreciate that shelf assemblies with fewer or additional shelves may be used without departing from the scope of the present disclosure.

The shelf assembly 12 may further include a first vertical shelf member 50, a second vertical shelf member 52 and a third vertical shelf member 54. The vertical shelf members 50, 52, 54 may be positioned between the right and left side walls 30, 32, and may be generally parallel with the side walls 30, 32.

The first vertical shelf member 50 may vertically extend between the first and second horizontal shelf members 34, 36. The first vertical shelf member 50 may define a first compartment 56 of the second shelf 44 of the shelf assembly 12. Specifically, the first compartment 56 may be defined by the first and second horizontal shelf members 34, 36, the right side wall 30 and the first vertical shelf member 50.

The second vertical shelf member 52 may vertically extend between the first and second horizontal shelf members 34, 36. The second vertical shelf member 52 may define a second compartment 58 of the second shelf 44 of the shelf assembly 12. Specifically, the second compartment 58 may be defined by the first and second horizontal shelf members 34, 36, the first vertical shelf member 50 and the second vertical shelf member 52.

The third vertical shelf member 54 may vertically extend between the first and second horizontal shelf members 34, 36. The third vertical shelf member 54 may define a third compartment 60 and a fourth compartment of the second shelf 44 of the shelf assembly 12. Specifically, the third compartment 60 may be defined by the first and second horizontal shelf members 34, 36, the second vertical shelf member 52 and the third vertical shelf member 54. The fourth compartment 62 may be defined by the first and second horizontal shelf members 34, 36, the third vertical shelf member 54 and the left side wall 32.

While three vertical shelf members 50, 52, 54 are shown defining four compartments 56, 58, 60, 62 within the second shelf 44 of the shelf assembly 12, those skilled in the art will appreciate that fewer or additional compartments may be formed in the second shelf 44, and that other shelves may also be provided with vertical shelf members to define compartments, without departing from the scope of the present disclosure.

The shelf assembly 12 may further include a banner member 64. The banner member 64 may laterally extend between the side walls 30, 32 of the shelf assembly 12, and may be marked with indicia 66, such as advertising text and/or graphics. For example, as shown in FIGS. 2 and 3, the banner member 64 may be connected to the shelf assembly 12 proximate (i.e., at or near) the upper end 68 of the shelf assembly 12 to maximize the visibility of the banner member 64 and associated indicia 66.

At this point, those skilled in the art will appreciate that the shelf assembly 12 may be formed from various materials, including wood, wood composites, metals, polymeric materials and combinations of suitable materials. The horizontal shelf members 34, 36, 38, 40 and vertical shelf members 50, 52, 54 may be integral with the side walls 30, 32 or may be connected to the side walls 30, 32 using various techniques (e.g., fasteners) that are well known in the art.

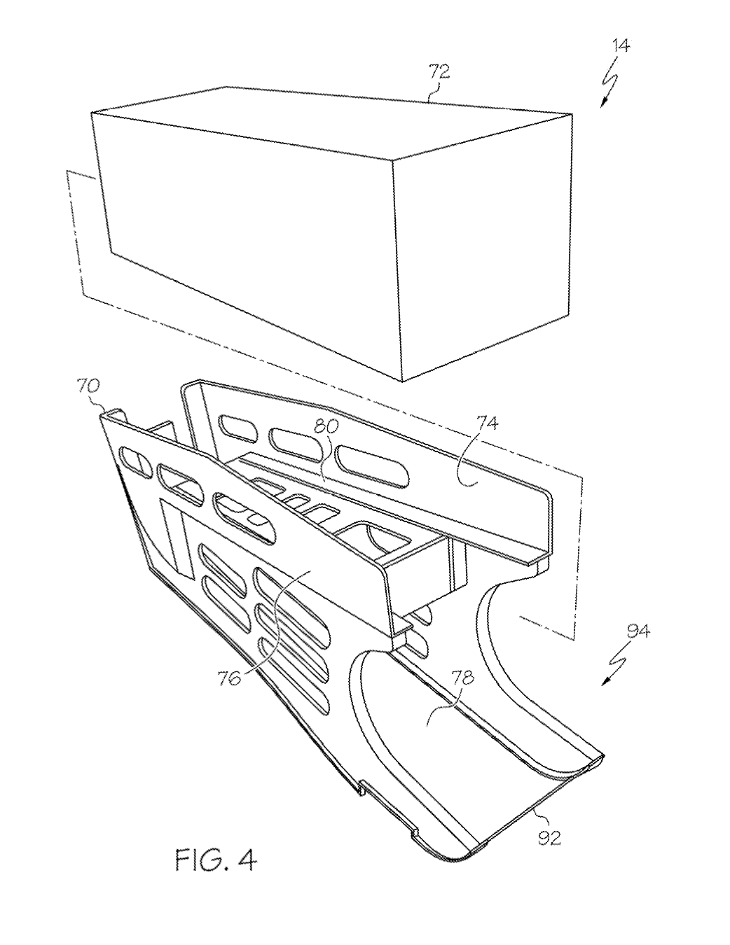

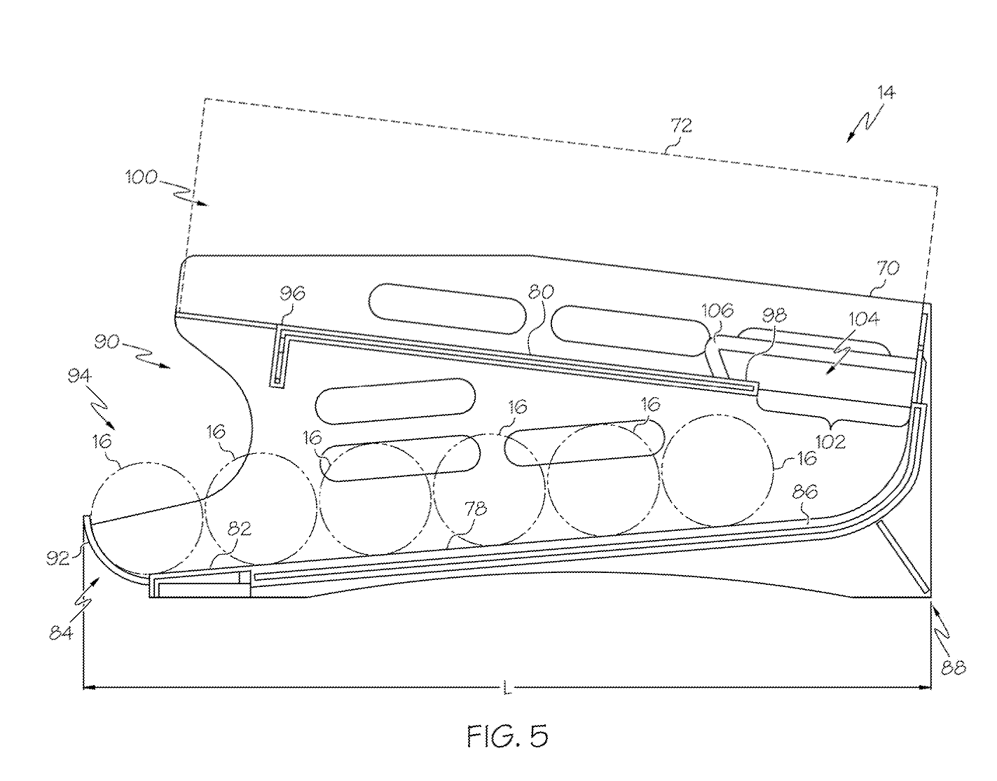

Referring to FIGS. 4 and 5, a product dispenser 14 of the disclosed product display and loading system 10 may include a dispenser frame 70 and a product container 72. The product container 72 may house multiple units of product 16, such as cans (e.g., canned food), jars (e.g., jarred sauce) or bottles (e.g., bottled soft drinks). When the product container 72 is loaded onto the dispenser frame 70, such as by urging the product container 72 along the dispenser frame 70, the dispenser frame 70 may automatically open the product container 72 and release the products 16 from the product container 72 to the dispenser frame 70.

The use of product dispensers 14 that require manually opening the product container 72 prior to loading the product container 72 onto the dispenser frame 70 is also contemplated.

The product container 72 may be any container capable of housing products 16 and beneficially interacting with the dispenser frame 70 to release and guide the products 16 to the dispenser frame 70. For example, the product container 72 may be a paperboard carton or a corrugated box. Optionally, at least one major surface of the product container 72 may be marked with various indicia, such as printed text and/or graphics.

The dispenser frame 70 may have a longitudinal length L (FIG. 5), and may include a first (right) side wall 74, a second (left) side wall 76, a lower support deck 78 and an upper support deck 80. The right side wall 74 may be laterally spaced from the left side wall 76, and may be generally parallel with the left side wall 76.

The lower support deck 78 may laterally extend between the right 74 and left 76 side walls, and may include a front end 82 that longitudinally extends toward the front end 84 of the dispenser frame 70 and a rear end 86 that longitudinally extends toward the rear end 88 of the dispenser frame 70. Therefore, the lower support deck 78 and the side walls 74, 76 may define a lower level 90 of the dispenser frame 70.

The lower support deck 78 may be inclined from the front end 82 to the rear end 86 such that products 16 deposited proximate the rear end 86 of the lower support deck 78 roll down to the front end 82 of the lower support deck 78 under the force of gravity. A stop 92 may be positioned proximate the front end 82 of the lower support deck 78 to prevent products 16 from rolling beyond the front end 82 of the lower support deck 78. For example, the stop 92 may be connected to (e.g., integral with) the lower support deck 78, and may form an upward curve at the front end 82 of the lower support deck 78. Therefore, the stop 92 may collect products 16 at the front end 82 of the lower support deck 78, thereby defining a product display area 94 at the front end 82 of the lower support deck 78.

The upper support deck 80 may laterally extend between the right and left side walls 74, 76, and may include a front end 96 that longitudinally extends toward the front end 84 of the dispenser frame 70 and a rear end 98 that longitudinally extends toward, but not to, the rear end 88 of the dispenser frame 70. Therefore, the upper support deck 80 and the side walls 74, 76 may define an upper level 100 of the dispenser frame 70.

The spacing 102 between the rear end 98 of the upper support deck 80 and the rear end 88 of the dispenser frame 70 may define an opening 104, which may function as a chute to allow products 16 to move from the upper level 100 to the lower level 90 of the dispenser frame 70.

The upper support deck 80 may be declined from the front end 96 to the rear end 98. Therefore, products 16 supported by the upper support deck 80 may roll under the force of gravity down to the rear end 98 of the upper support deck 80, through the opening 104, to the lower level 90 of the dispenser frame 70 and, ultimately, to the product display area 94. Consumers may retrieve products 16 from the product display area 94.

The dispenser frame 70 may further include an opening tool 106. The opening tool 106 may be positioned to sever the product container 72 as the product container 72 is urged generally horizontally along the upper support deck 80 toward the rear end 88 of the dispenser frame 70. By severing the product container 72, the opening tool 106 may form an exit opening in the product container 72, which may be aligned with the opening 104 when the product container 72 is fully loaded onto the dispenser frame 70. With the exit opening formed in the product container 72, the products 16 initially housed in the product container 72 may exit the product container 72 through the exit opening, pass through the opening 104 defined by the dispenser frame 70 and drop down to the lower level 90 of the dispenser frame 70 and, ultimately, move to the product display area 94.

Product dispensers, as well as opening tools for automatically opening product containers as they are being loaded onto dispenser frames, are discussed in greater detail in in U.S. Pat. No. 7,922,437, which issued on Apr. 12, 2011. The entire contents of U.S. Pat. No. 7,922,437 are incorporated herein by reference.

The loading container 18 of the disclosed product display and loading system 10 may be any container capable of receiving and supporting at least one product 16. Therefore, a consumer may retrieve one or more products 16 from the product display area 94 of a product dispenser 14 of the product display and loading system 10, and may place the retrieved product 16 into the loading container 18. The loading container 18 may continue to support the product 16 as the product 16 is transported away from the product display and loading system 10 (e.g., as the product 16 is transported to a check-out counter and/or the consumer's home).

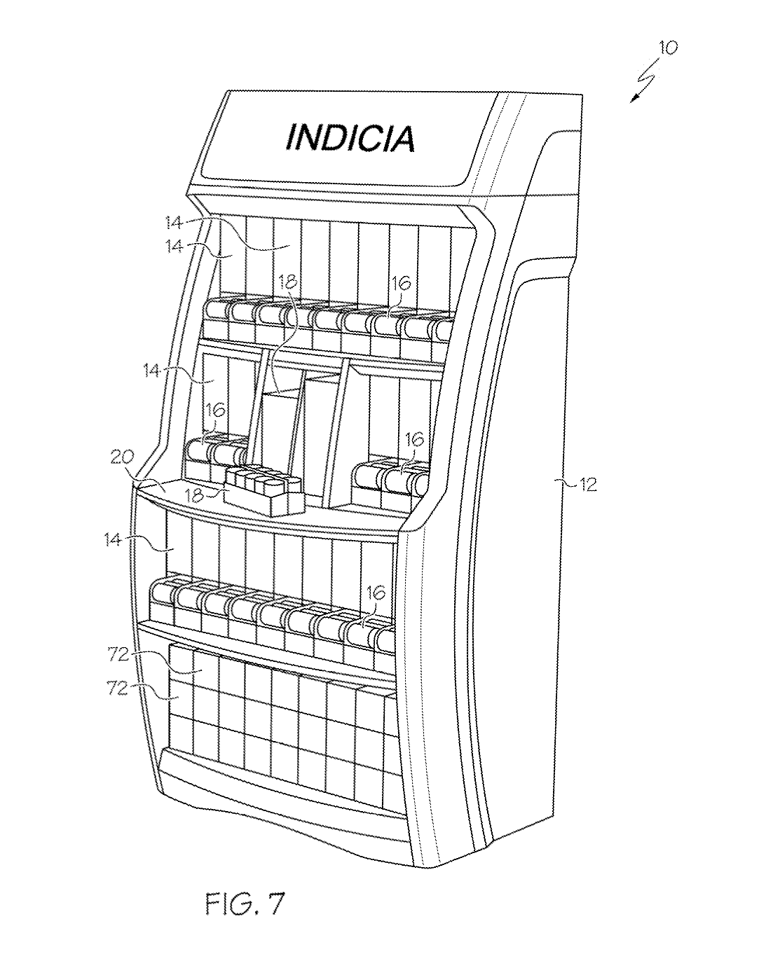

Referring to FIG. 6, in one particular embodiment, the loading container 18 may be configured as a tray having a base wall 110 and side walls 112, 114, 116, 118 connected to the base wall 110 to define an internal volume 120. Therefore, the base wall 110 and side walls 112, 114, 116, 118 may retain products 16 (FIG. 7) within the internal volume 120 of the loading container 18 during transport.

In one optional implementation, the loading container 18 may include one or more dividers (not shown) extending between the side walls 112, 114, 116, 118 of the loading container 18. The dividers may divide the internal volume 120 into two or more compartments (not shown), as is commonly done with certain beverages, such as wine bottles, that are packaged in cases. Each compartment may be sized to closely receive a single product 16, thereby minimizing (if not eliminating) movement of the products 16 within the loading container 18 during transport.

In another optional implementation, the loading container 18 may include a carry handle (not shown). The carry handle may facilitate carrying the loaded loading container 18 away from the product display and loading system 10.

Referring to FIG. 7, the shelf assembly 12 may be loaded with one or more product dispensers 14 and one or more loading containers 18. The product dispensers 14 may be arranged in a side-by-side configuration across the shelf assembly 12. The loading containers 18 may be stacked (e.g., nested) and positioned in one or more compartments 58, 60 of the shelf assembly 12.

For example, referring to FIGS. 2 and 7, the first shelf 42 may have a lateral width W₁ and a vertical height H₁ sufficient to accommodate a plurality of product dispensers 14 arranged in a side-by-side configuration across the first shelf 42. While nine product dispensers 14 are shown on the first shelf 42, those skilled in the art will appreciate that the number of product dispensers 14 on the first shelf 42 may depend on, among other possible factors, the lateral width W₁ of the first shelf 42 and the lateral width of each product dispenser 14.

The second shelf 44 may have a lateral width W₂ and a vertical height H₂ sufficient to accommodate a first quantity of product dispensers 14 arranged in a side-by-side configuration in the first compartment 56, a first quantity of loading containers 18 positioned in the second compartment 58, a second quantity of loading containers 18 positioned in the third compartment 60 and a second quantity of product dispensers 14 arranged in a side-by-side configuration in the fourth compartment 62.

The shelf depth D₂ of the second shelf 44 may be significantly greater than the longitudinal length L (FIG. 5) of the product dispensers 14 positioned on the second shelf member 36. As one example, the shelf depth D₂ may be at least 1.2 times the longitudinal length L of the product dispensers 14. As another example, the shelf depth D₂ may be at least 1.5 times the longitudinal length L of the product dispensers 14. As yet another example, the shelf depth D₂ may be at least 2 times the longitudinal length L of the product dispensers 14.

Therefore, the significantly greater shelf depth D₂ of the second shelf 44 may ensure that the product dispensers 14 do not extend onto the forward end 19 (FIG. 3) of the second shelf member 36, thereby defining the loading surface 20 at the forward end 19 of the second shelf member 36 and ensuring that the loading surface 20 is unobstructed and capable of supporting loading containers 18.

The third shelf 46 may have a lateral width W₃ and a vertical height H₃ sufficient to accommodate a plurality of product dispensers 14 arranged in a side-by-side configuration across the third shelf 42. While nine product dispensers 14 are shown on the third shelf 46, those skilled in the art will appreciate that the number of product dispensers 14 on the third shelf 46 may depend on, among other possible factors, the lateral width W₃ of the third shelf 46 and the lateral width of each product dispenser 14.

The fourth shelf 48 may have a lateral width W₄ and a vertical height H₄ sufficient to accommodate a plurality of product dispensers 14 arranged in a side-by-side configuration across the fourth shelf 48. However, as shown in FIGS. 1 and 7, the fourth shelf 48 may alternatively be used to store extra product containers 72. Therefore, when a product dispenser 14 of the product display and loading system 10 has been depleted, a user (e.g., a stock clerk) may remove the depleted product container 72 from the product dispenser 14 and replace it with a full product container 72 retrieved from the fourth shelf 48.

Accordingly, as shown in FIG. 7, a consumer may select a loading container 18 from the shelf assembly 12 and may place the loading container 18 onto the loading surface 20 of the shelf assembly 12. Then, the consumer may retrieve products 16 from the product display areas 94 (FIG. 4) of the product dispensers 14 supported on the shelf assembly 12, and may load the retrieved products 16 into the loading container 18 supported on the loading surface 20 of the shelf assembly 12.

Although various aspects of the disclosed product display and loading system have been shown and described, modifications may occur to those skilled in the art upon reading the specification. The present application includes such modifications and is limited only by the scope of the claims.

What is claimed is:

1. A product display and loading system comprising:
a shelf assembly comprising a generally horizontal shelf member having a forward end and a rear end; and
a product dispenser positioned on said horizontal shelf member, said product dispenser being spaced from said forward end to define a loading surface proximate said forward end.

2. The product display and loading system of claim 1 comprising a plurality of product dispensers positioned on said horizontal shelf member, said plurality of product dispensers being spaced from said forward end to define said loading surface proximate said forward end.

3. The product display and loading system of claim 1 wherein said shelf assembly comprises a first side wall laterally spaced from a second side wall, and wherein said horizontal shelf member laterally extends between said first side wall and said second side wall.

4. The product display and loading system of claim 1 wherein said shelf assembly further comprises a generally vertical shelf member, and wherein said horizontal shelf member and said vertical shelf member define a first compartment and a second compartment, said first compartment being separated by said second compartment by said vertical shelf member.

5. The product display and loading system of claim 1 wherein said shelf assembly further comprises a second horizontal shelf member.

6. The product display and loading system of claim 5 wherein said second horizontal shelf member is positioned above said horizontal shelf member.

7. The product display and loading system of claim 5 wherein said second horizontal shelf member is positioned below said horizontal shelf member.

8. The product display and loading system of claim 1 wherein said shelf assembly further comprises a banner member, said banner member being marked with indicia.

9. The product display and loading system of claim 1 further comprising a plurality of loading containers positioned on said horizontal shelf member.

10. The product display and loading system of claim 9 wherein at least one loading container of said plurality of loading containers is positioned on said loading surface.

11. The product display and loading system of claim 10 wherein said loading container is sized to fit between said forward end of said horizontal shelf member and said product dispenser.

12. The product display and loading system of claim 1 wherein said shelf assembly comprises a base, and wherein said horizontal shelf member is vertically spaced a distance from said base.

13. The product display and loading system of claim 12 wherein said distance is at least 30 inches.

14. The product display and loading system of claim 12 wherein said distance is at least 36 inches.

15. The product display and loading system of claim 1 wherein said horizontal shelf member has a shelf depth and said product dispenser has a longitudinal length, and wherein said shelf depth is at least 1.2 times said longitudinal length.

16. The product display and loading system of claim 1 wherein said product dispenser comprises a dispenser frame and a product container supported on said dispenser frame, said product container housing a plurality of products.

17. The product display and loading system of claim 16 wherein said dispenser frame comprises an upper support deck and a product display area below said upper support deck.

18. The product display and loading system of claim 17 wherein said dispenser frame further comprises an opening tool arranged to automatically open said product container and at least partially dispense said plurality of products from said product container into said product display area when said product container is moved along said upper support deck.

19. A product display and loading system comprising:
a shelf assembly comprising a generally horizontal shelf member having a forward end and a rear end;
a plurality of product dispensers positioned on said horizontal shelf member, said plurality of product dispensers being spaced from said forward end to define a loading surface proximate said forward end; and
a plurality of loading containers supported on said shelf assembly,
wherein each loading container of said plurality of loading containers is sized to fit between said forward end and said plurality of product dispensers when said loading container is positioned on said loading surface.

20. A method for loading a product from a product display into a loading container, said method comprising the steps of:
providing a shelf assembly comprising a generally horizontal shelf member having a forward end and a rear end;
positioning a product dispenser on said horizontal shelf member such that said product dispenser is spaced from said forward end of said horizontal shelf member to define a loading surface proximate said forward end, said product dispenser supporting said product;
positioning said loading container on said loading surface; and
transferring said product from said product dispenser to said loading container.
